(19) United States
(12) Patent Application Publication
(10) Pub. No.: US 2013/0310968 A1
(43) Pub. Date: Nov. 21, 2013

(54) PAINT CHIP DISPENSER

(71) Applicant: Roelof Johannes Baptist Gottenbos, Leiderdorp (NL)

(72) Inventor: Roelof Johannes Baptist Gottenbos, Leiderdorp (NL)

(21) Appl. No.: 13/995,385

(22) PCT Filed: Dec. 19, 2011
(86) PCT No.: PCT/EP2011/073163

§ 371 Date: Jun. 18, 2013

Related U.S. Application Data
(60) Provisional application No. 61/425,344, filed on Dec. 21, 2010.

(30) Foreign Application Priority Data
Dec. 21, 2010 (EP) 10196279.3

(51) Int. Cl. B44D 3/00

(52) U.S. Cl. CPC B44D 3/00
USPC 700/215

(57) ABSTRACT

The invention relates to an apparatus under the control of an electronic data processing unit for selecting and dispensing paint chips, comprising a) a plurality of paint chips, each paint chip comprising i) a substrate and having applied thereto at least one paint layer having specified visual appearance properties, and ii) a paint chip identifier comprising a machine readable code, b) a data input unit for entering visual appearance properties identification criteria c) a paint chip storage unit having paint chip storage locations, each paint chip storage location having a unique paint chip storage location address, d) a paint chip selection and dispensing unit capable of selecting and dispensing paint chips in response to entered visual appearance properties identification criteria, e) a paint chip receiving unit.

The invention relates to an apparatus for selecting and dispensing paint chips. The invention further relates to a process of selecting a repair paint formula matching the visual appearance properties of an object to be repair painted.

In the automobile refinish industry finding a repair paint that matches the visual appearance of the original paint is of paramount importance to achieve so-called invisible repairs. In order to assist the repair painter in selecting the correct formula for the repair paint, use is often made of paint chips. The paint chips are substrates coated with a repair paint having specified visual appearance properties. Each individual paint chip is suitably associated with a specific repair paint recipe. Typically, thousands of paint chips in all possible shades and variants are required in every automobile repair body shop as color documentation material. The paint chips are usually packed in swatches of a plurality of individual paint chips. The paint chips are suitably sorted according to color, or to automobile brand and additional information, such as the manufacturer's color code or color name.

Based on this information, the repair painter can retrieve a number of candidate paint chips from the color documentation material. By visual comparison with the automobile to be repair painted, the best matching paint chip can be identified, and the associated paint recipe can be retrieved from a database. Subsequently, the candidate paint chips have to be returned to their original position in the color documentation material. This process as such is time consuming and prone to human errors. In addition, the color documentation material has to be updated regularly, for example when new automobile colors appear on the market. Implementation of such updates is relatively costly, as it involves substantial manual activity. Hence, there is a need for an improvement of paint chip handling in the automobile refinish industry which addresses these drawbacks.

International patent application WO 2009/132420 A describes an apparatus for use in dispensing tinted paint. The apparatus comprises a plurality of sets of paint chips, each comprising a substrate and having applied thereto at least one paint sample of a selected shade; a paint chip display stand having a plurality of receptables each for receiving one of the sets; each paint chip having applied thereto a component defining a readable code. The recipe can be stored on the chip as part of the code, but more preferably it is retained on a memory at the dispensing system or at a remote location.

The invention provides an apparatus under the control of an electronic data processing unit for selecting and dispensing paint chips, comprising
a) a plurality of paint chips, each paint chip comprising
   i) a substrate and having applied thereto at least one paint layer having specified visual appearance properties, and
   ii) a paint chip identifier comprising a machine readable code,
b) a data input unit for entering visual appearance properties identification criteria
c) a paint chip storage unit having paint chip storage locations, each paint chip storage location having a unique paint chip storage location address,
d) a paint chip selection and dispensing unit capable of selecting and dispensing paint chips in response to entered visual appearance properties identification criteria,
e) a paint chip receiving unit.

The apparatus according to the invention improves the paint chip handling processes in the automobile refinish industry. In particular, it allows an easy updating of the color documentation materials, because new paint chips can be added to the apparatus easily. Furthermore, after use the paint chips may be entered in the paint chip receiving unit of the apparatus, whereupon the paint chips are returned into the paint chip storage unit. Hence, there is no need to return paint chips or swatches manually into the color documentation material. This saves time and reduces the chance of human errors being made.

The paint chips comprise a substrate and at least one paint layer applied thereto. The substrate may be made of any suitable material, such as metal, plastic, wood, cardboard or paper. Also combinations of materials, for example laminates, can be used. The paint chips can have any suitable shape, such a round, oval or angular. The paint chips generally are essentially flat with two major surfaces. The at least one paint layer is applied to at least a part of at least one of the major surfaces. The paint chip may also comprise more than one paint layer, for example a primer layer, a color and/or effect imparting base coat layer, and a clear top coat layer. The paint layer has specified visual appearance properties. This means that the visual appearance properties, such as color, texture and gloss, are known and documented. Typically, the visual appearance properties are stored in a database. Alternatively, the visual appearance property data may be stored or encoded on the paint chip itself, for example in machine readable form, such as a bar code, a computer readable memory, or a radio frequency identification tag.

Each paint chip also comprises a paint chip identifier comprising a machine readable code. This allows individual paint chips to be identified by the apparatus during paint chip selection, dispensing and receiving activities. Specific examples of the chip identifier may be embodied in the form of a bar code, a computer readable memory, or a radio frequency identification tag. In one embodiment, the visual appearance property data are stored in the paint chip identifier.

The apparatus further comprises a data input unit for entering visual appearance properties identification criteria. Examples of suitable data input units include a computer keyboard, a touch screen device, a bar code reader, or a data interface which can transfer spectroscopic data, for example from a spectrophotometer, to the electronic data processing unit. The data input unit is used to enter visual appearance properties identification criteria in the electronic data processing unit.

Visual appearance properties include properties such as color and gloss. Besides color, a paint film shows numerous further visual properties. Particularly when effect pigments, such as for example aluminum flake pigments or pearlescent pigments, are used, the look of a paint film is not of a uniform color, but shows texture. This can include phenomena as coarseness, glints, micro-brilliance, cloudiness, mottle, speckle, sparkle or glitter. In the following, texture is defined as the visible surface structure in the plane of the paint film depending on the size and organization of small constituent parts of a material. In this context, texture does not include roughness of the paint film but only the visual irregularities in the plane of the paint film. Structures smaller than the resolution of the human eye, contribute to “colour”, whereas larger structures generally also contribute to “texture”. The visual appearance data may also include the angle-dependency of the above-mentioned visual properties, for example the viewing angle-dependency and/or the incident light angle-dependency. In one embodiment, the visual appearance properties identification criteria entered into the electronic data processing unit are measurement data relating to the above-mentioned properties, for example spectrophotometric or digital image data of the exterior coated surface of an automobile which needs to be refinished. Alternatively, the visual appearance properties can be identified by other criteria, for example the color code or color name of a vehicle manufacturer, the brand, model year or manufacturing site of an automobile. It is also possible to enter a combination of different visual appearance properties identification criteria. In the electronic data processing unit the entered visual appearance properties identification criteria are suitably translated into corresponding visual appearance data. The visual appearance data may be used to assign a unique storage location for a paint chip.

The apparatus further comprises a paint chip storage unit wherein the paint chips are stored in paint chip storage locations. Each paint chip storage location is equipped to store one paint chip and each storage location has a unique paint chip storage location address. In a very simple embodiment, the paint chip storage location address is number which reflects the order in which the paint chips were entered into the paint chip storage unit. In combination with the paint chip identifiers it is thus possible to keep track of the residence of all paint chips in a database or in the memory of the electronic data processing unit controlling the apparatus. In one embodiment, each paint chip is assigned to a fixed paint chip storage location. In this embodiment, a paint chip re-inserted in the apparatus via the paint chip receiving unit will be stored in the original paint chip storage location from which it was retrieved. Alternatively, a free storage location can be selected individually in each case that a paint chip is placed in a storage location.

The apparatus has a paint chip selection and dispensing unit. The paint chip selection and dispensing unit is capable of selecting and dispensing paint chips in response to entered visual appearance properties identification criteria. Generally, the paint chip selection unit will select one or more paint chips of which the specified visual appearance properties have the best match with the visual appearance properties corresponding to the entered visual appearance properties identification criteria. Alternatively, it is also possible that the selection is based in on prescribed, specific visual appearance differences, for example when paint chips having a slightly darker color than corresponding to the entered visual appearance properties identification criteria are sought. This can be carried out by comparing the visual appearance properties of the paint chips with those corresponding to the entered identification criteria. The number of selected paint chips usually does not exceed 10 per entered visual appearance identification criteria set. The number of selected paint chips will depend on a threshold value which can be set for the degree of matching of the visual appearance properties data, such as color difference or texture difference. Once the paint chips have been selected, the dispensing unit identifies the storage locations of the selected paint chips in the paint chip storage unit. The dispensing unit is equipped to retrieve the selected paint chips from their respective storage locations and to dispense them to a user. The selected paint chips are suitably delivered to a dispensing opening. The selected paint chips can be delivered individually. Alternatively, the selected paint chips may first be collected in an intermediate container in which they are dispensed collectively. The mechanical installations required to operate the apparatus, including the selection and dispensing unit, are generally known, for example from vending machines and article handling systems used in warehouses. United States patents U.S. Pat. No. 3,002,602 and U.S. Pat. No. 4,039,785 may be mentioned as specific examples wherein such systems are described.

The apparatus also comprises a paint chip receiving unit. The paint chip receiving unit is suitable for re-inserting dispensed paint chips, for example after they have been used to compare the visual appearance properties of the paint chips with the visual appearance properties of a painted object. The paint chip receiving unit suitably comprises or is connected to a paint chip identification unit capable of reading the paint chip identifier. After identification of the re-inserted paint chip, the paint chip is suitably delivered to a paint chip storage location. The paint chip receiving unit may also be used to update the apparatus with new paint chips, either as replacement for worn existing paint chips, or for introducing additional paint colors. In one embodiment, the dispensing opening mentioned above may also serve as paint chip receiving unit. Alternatively, the paint chip receiving unit may be constituted by an additional opening of the apparatus. In one embodiment, the apparatus further comprises a paint chip control unit. The paint chip status control unit can be used to automatically check if individual paint chips are worn out or damaged. The paint chip control unit suitably establishes whether the visual appearance properties of a paint chip are within defined limits. Also the dimensional integrity or the weight of the paint chips may be controlled by suitable sensors. The paint chip control unit may for example comprise a gloss meter which compares the actual gloss of a paint chip with the gloss data of that paint chip stored in the database. The paint chip control unit may also compare color and/or texture of a specific paint chip with data stored in a database. When the difference of measured values and stored values is outside predefined limits, the paint chip control unit suitable causes a warning to be issued, indicating that a specific paint chip needs to be replaced. In some embodiments, the paint chip control unit can be integrated into the paint chip dispensing or the paint chip receiving unit. In this case, each paint chip can be controlled and checked each time it is dispensed or inserted into the apparatus.

In a further embodiment, each paint chip is associated with the recipe of the paint applied to that chip. The paint recipes may be stored in a paint recipe database, wherein each paint chip is linked to a specific paint recipe for each particular paint product. Alternatively or additionally, the paint recipes may be stored on the paint chip itself, for example in a machine readable memory device which is part of the paint chip. The associated paint recipes may also be stored in the paint chip identifier of each paint chip.

In a still further embodiment, the apparatus of the invention also has a paint recipe output unit. The paint recipe output unit can be used to provide the user with the paint recipes of the paints corresponding to the paint layers of the dispensed paint chips. The paint recipe output unit may be implemented as an electronic display screen, on which the paint recipe, in the form of components and relative amounts, is displayed, optionally in combination with procedural steps to be taken to prepare the paint. Alternatively, or additionally, the paint recipes may be sent to a printer to generate a hard copy of the respective paint recipes.

The invention further relates to a process of selecting a paint chip matching the visual appearance properties of an object to be repair painted, comprising the steps of
a) establishing visual appearance properties identification criteria of the object to be repair painted,
b) entering the visual appearance properties identification criteria into the data input unit of the apparatus according to the invention,
c) initiating the apparatus to carry out a paint chip selection and dispensing process in response to entered visual appearance properties identification criteria,
d) comparing the visual appearance properties of the dispensed paint chips and the object to be repair painted, and
e) selecting the paint chip having the best match of visual appearance properties with the object to be repair painted.

The process simplifies the selection of a paint chip having the best match with the visual appearance properties of an object to be repair painted. The object to be repair painted may be an automobile or other transport vehicle which needs to be partly repainted in the course of a collision repair. In such cases, it is particularly important to achieve a good match of the visual appearance properties of the repair painted parts and the original paint.

In the first step of the process, the visual appearance properties identification criteria of the object to be repair painted are established. The visual appearance properties identification criteria to be established are those mentioned above, e.g. measurement data, such as spectrophotometric or digital image data of the exterior coated surface of an automobile which needs to be refinished, or other criteria, for example the color code or color name of a vehicle manufacturer, the brand, model year or manufacturing site of an automobile. Combinations of these criteria may likewise be used. Subsequently, the user enters the visual appearance properties identification criteria into the data input unit of the apparatus of the invention, and the apparatus is initiated to carry out a paint chip selection and dispensing process. The selection and dispensing process can for example be initiated when the user confirms that entry of the identification criteria is complete. The selection process starts with establishing the visual appearance property data corresponding to the entered visual appearance properties identification criteria. If the entered visual appearance properties identification criteria are spectroscopic data of a paint surface to be matched, the visual appearance properties identification criteria and the visual appearance properties data may be identical. If the entered visual appearance properties identification criteria are, for example, color code or color name of a vehicle manufacturer, the corresponding visual appearance data are suitably retrieved from a database wherein visual appearance data are linked to visual appearance properties identification criteria. Once the visual appearance property data have been established, the paint chip selection unit suitably selects one or more paint chips of which the specified visual appearance properties have the best match with the visual appearance properties corresponding to the entered visual appearance properties identification criteria. This is typically carried out by comparing database stored visual appearance properties of the paint chips with those corresponding to the entered identification criteria. In one embodiment, 5 paint chips having the closest matches may be selected. The storage locations of the selected paint chips are then established, typically from a database containing the storage location of all paint chips. The dispensing unit then retrieves the selected paint chips from their respective storage locations and dispenses them to a user. The selected paint chips are suitably delivered to a dispensing opening. The user may then collect the dispensed paint chips and compare the visual appearance properties of the dispensed paint chips and the object to be repair painted. In one embodiment, the user may carry out a visual comparison. Alternatively, the comparison may be carried out using a measurement apparatus, such as a spectrophotometer and/or a digital imaging device. The user then selects the paint chip having the best match of visual appearance properties with the object to be repaired. In one embodiment, the user may also enter identification criteria of the paint chip having the best match of visual properties in the data input unit. In this way, the selection having the best match is made available to the electronic data processing unit of the apparatus. In a still further embodiment, the paint recipe associated with the selected paint chip having the best match of visual properties is retrieved, typically from a database wherein the paint chips are linked to the recipes of the paint layer applied to them. Once retrieved, the paint recipe is sent to a paint recipe output unit, for example an electronic display screen or a printer.

In a still further embodiment, the user re-inserts the dispensed paint chips in the apparatus via the paint chip receiving unit. The paint chip is suitably subjected to a paint chip identification reading the paint chip identifier. After identification of the re-inserted paint chip, the paint chip is delivered to a paint chip storage location. When the apparatus comprises a paint chip control unit, the paint chips can be controlled for damages prior to being delivered to a paint chip storage location.

1) An apparatus under the control of an electronic data processing unit for selecting and dispensing paint chips, comprising
a) a plurality of paint chips, each paint chip comprising
i) a substrate and having applied thereto at least one paint layer having specified visual appearance properties, and
ii) a paint chip identifier comprising a machine readable code,
b) a data input unit for entering visual appearance properties identification criteria
c) a paint chip storage unit having paint chip storage locations, each paint chip storage location having a unique paint chip storage location address,
d) a paint chip selection and dispensing unit capable of selecting and dispensing paint chips in response to entered visual appearance properties identification criteria,
e) a paint chip receiving unit.

2) The apparatus according to claim 1, wherein each paint chip is associated with a recipe of the paint applied to that chip.

3) The apparatus according to claim 2, wherein the paint recipes are stored in the paint chip identifier of each chip.

4) The apparatus according to claim 2, wherein the paint recipes are stored in a paint recipe database.

5) The apparatus according to claim 2, further comprising a paint recipe output unit.

6) The apparatus according to claim 1, further comprising a paint chip control unit.

7) A process of selecting a paint chip matching the visual appearance properties of an object to be repair painted, comprising the steps of
a) establishing visual appearance properties identification criteria of the object to be repair painted,
b) entering the visual appearance properties identification criteria into a data input unit;
c) initiating the apparatus of claim 1 to carry out a paint chip selection and dispensing process in response to entered visual appearance properties identification criteria,
d) visually comparing the visual appearance properties of the dispensed paint chips and the object to be repair painted, and
e) selecting the paint chip having the best match of visual appearance properties with the object to be repair painted.

8) The process according to claim 7, further comprising the additional step of
f) entering identification criteria of the paint chip having the best match of visual properties in the data input unit.

9) The process according to claim 8, further comprising the additional steps of
g) retrieving the paint recipe associated with the paint chip having the best match of visual properties, and
h) sending the paint recipe to the paint recipe output unit of the apparatus.

10) The process according to claim 7, further comprising the additional step of
f) re-inserting the dispensed paint chips in the apparatus via the paint chip receiving unit.

11) A process of selecting a paint chip matching the visual appearance properties of an object to be repair painted, comprising the steps of
a) establishing visual appearance properties identification criteria of the object to be repair painted,
b) entering the visual appearance properties identification criteria into a data input unit,
c) initiating the apparatus of claim 5 to carry out a paint chip selection and dispensing process in response to entered visual appearance properties identification criteria,
d) visually comparing the visual appearance properties of the dispensed paint chips and the object to be repair painted, and
e) selecting the paint chip having the best match of visual appearance properties with the object to be repair painted.

12) The process according to claim 11, further comprising the additional step of
f) entering identification criteria of the paint chip having the best match of visual properties in the data input unit.

13) The process according to claim 12, further comprising the additional steps of
g) retrieving the paint recipe associated with the paint chip having the best best match of visual properties, and
h) sending the paint recipe to the paint recipe output unit of the apparatus.

14) The process according to claim 11, further comprising the additional step of
f) re-inserting the dispensed paint chips in the apparatus via the paint chip receiving unit.
